(19) United States
(12) Patent Application Publication
(10) Pub. No.: US 2008/0272312 A1
(43) Pub. Date: Nov. 6, 2008

(54) Hyperspectral fluorescence and absorption bioimaging

(75) Inventor: David Tuschel, Monroeville, PA (US)

Correspondence Address: CHEMIMAGE CORPORATION, 7301 PENN AVENUE, PITTSBURGH, PA, 15208, US

(73) Assignee: Chemimage Corporation

(21) Appl. No.: 12/148,199

(22) Filed: Apr. 17, 2008

Related U.S. Application Data
(60) Provisional application No. 60/915,948, filed on May 4, 2007.

(51) Int. Cl. G01J 1/58

(52) U.S. Cl. 250/459.1; 250/208.1

(57) ABSTRACT

A system and method of hyperspectral chemical imaging (fluorescence or absorption based) to provide an automated approach for a more detailed analysis of disease status of a biological sample. When a biological sample is labeled with a fluorescent or light-absorbing contrast-enhancing agent, interactions between the contrast-enhancing agent and one or more constituents (or cellular components) of the biological sample may be manifested through spectral contents of a plurality of regions in a hyperspectral chemical image of the sample. Observations of such manifestations through analysis of corresponding spectral contents may greatly assist a user (e.g., a pathologist) in detecting and differentiating diseased portions of the stained sample. Hyperspectral chemical imaging may allow to identify multiple cellular components within a biological sample and to image their distribution within the sample, thereby assisting a pathologist to successfully and more accurately identify diseased portion(s) of the sample for further diagnosis and treatment.

### REFERENCE TO RELATED APPLICATION

The disclosure in the present application claims priority benefit under 35 U.S.C. § 119(e) of the U.S. Provisional Application No. 60/915,948, titled “Hyperspectral Fluorescence Bioimaging,” and filed on May 4, 2007, the disclosure of which is incorporated herein by reference in its entirety.

### BACKGROUND

1. Field of the Disclosure

The present disclosure generally relates to chemical imaging of biological tissues and samples and, more particularly, to a system and method to detect and differentiate diseased portions of a biological tissue or sample using hyperspectral fluorescence or absorption chemical imaging.

2. Brief Description of Related Art

Fluorescence is the result of a three-stage process that occurs in certain molecules called fluorophores or fluorescent dyes. In the first stage of the process, photon energy supplied from an external source such as an incandescent lamp or a laser diode is absorbed by the fluorophore, creating an excited electronic state of the fluorophore. The second stage of the process occurs during the excited-state of the fluorophore, in which the fluorophore undergoes conformational changes and is also subject to multitude of possible interactions with its molecular environment. Finally, in the third stage of the process, photon emissions occur in the form of fluorescence, returning the fluorophore to its ground energy state.

Generally, the entire fluorescence process is cyclical, unless the fluorophore is irreversibly destroyed in the excited state by photobleaching. Thus, the same fluorophore can be repeatedly excited and detected (through detection of its characteristic fluorescence emissions). The fluorescence emission intensity of a fluorophore is proportional to the amplitude of the fluorescence excitation spectrum at the excitation wavelength. Thus, excitation of a fluorophore at three different excitation wavelengths does not change the emission profile of the fluorophore, but it does produce variations in fluorescence emission intensity that correspond to the amplitude of the excitation spectrum.

Fluorescence detection systems typically include four elements: (i) an excitation source, (ii) a fluorophore (e.g., a suitable stain, cellular probe, or other contrast-enhancing agent), (iii) a wavelength filter to isolate emission photons from excitation photons, and (iv) a detector that registers emission photons and produces a recordable output, usually as an electrical signal or a photographic image. Some examples of fluorescence detection instruments include spectrofluorometers, fluorescence microscopes, fluorescence scanners, and flow cytometers. In case of fluorescence microscopes, it is observed that such microscopes resolve fluorescence as a function of spatial coordinates in two or three dimensions for microscopic objects. However, fluorescence microscopy suffers from certain known limitations such as, for example, presence of spatial artifacts, errors in quantitative measurements due to spectral bleed-through, reduction in detection sensitivity due to sample autofluorescence or reagent background fluorescence, effects of probe co-localization, or degradation in fluorescence image contrast.

In case of a microscopic examination of a biological tissue or sample stained with a fluorescent contrast-enhancing agent, a trained pathologist may be able to identify diseased (e.g., cancerous) portions of the tissue based on the stain-specific changes in colors observed throughout the tissue in the microscopic image. For example, in case of a prostate tissue stained with Hematoxylin and Eosin (H&E) stain, the pathologist may be able to identify cell nuclei from cytoplasm based on the observation that nuclei stain blue whereas cytoplasm stains pink in response to H&E staining. If any other stain is used, the colors may be different. In any event, the stain-specific color profile of various cellular components may be known beforehand to assist the pathologist in quick determination of the disease status of the tissue. However, such preliminary examination by a pathologist may not be sufficient or fully accurate in view of the limitations inherent in fluorescence microscopy. Thus, in addition to a visual inspection of the stained tissue by a human pathologist, it may be desirable to devise a machine-based approach to a more detailed analysis of disease status of the tissue sample, which not only may be beneficial to the pathologist in further diagnosis of the sample, but may also present the pathologist with additional information needed to successfully and more accurately identify the diseased portions of the tissue sample.

It is observed here that reagent-less Raman spectroscopy and spectroscopic imaging methods have been employed in the industry as a solution to the need for such detailed tissue diagnosis. However, in view of prevalence of tissue staining and fluorescence-based tissue diagnosis in pathological laboratories, and further in view of natural fluorescence occurring in many biological samples (which may not be favorable to a Raman diagnosis), it is desirable to devise an expeditious and relatively less expensive system and method that uses hyperspectral fluorescence or absorption (by transmission or reflection) imaging to not only detect and differentiate diseased portions of stained tissues, but also to identify the tissue-wide distribution of cellular components and to determine the identity of the components based on the fluorescence (or absorption by transmission or reflection) imaging of the spectral profile resulting from the chemical interactions or bindings of a contrast-enhancing agent with various cellular components in the tissue sample.

### SUMMARY

In one embodiment, the present disclosure relates to a method that comprises: illuminating a two dimensional (2D) portion of a biological sample with a first plurality of photons from a monochromatic light source, wherein the biological sample is stained with a fluorescent contrast-enhancing agent; collecting a second plurality of photons emitted from the illuminated portion to thereby obtain a hyperspectral fluorescence image of the portion of the sample; and observing manifestations of chemical interactions between the contrast-enhancing agent and one or more constituents of the biological sample by analyzing spectral content of a plurality of regions in the hyperspectral fluorescence image.

In another embodiment, the present disclosure relates to a system that comprises: a monochromatic illumination source configured to illuminate a two dimensional (2D) portion of a biological sample with a first plurality of photons, wherein the biological sample is stained with a fluorescent contrast-enhancing agent; a collection optics to collect a second plurality of photons emitted from the illuminated portion of the sample; a detector unit configured to receive at least a portion of the second plurality of photons from the collection optics and to enable generation of a hyperspectral fluorescence image of the portion of the sample from the received portion of the second plurality of photons; and a processing unit coupled to the detector unit and configured to enable observation of manifestations of chemical interactions between the contrast-enhancing agent and one or more constituents of the biological sample by analyzing spectral content of a plurality of regions in the hyperspectral fluorescence image.

In a further embodiment, the present disclosure relates to a method that comprises: illuminating a two dimensional (2D) portion of a biological sample with a first plurality of photons from a broadband light source, wherein the biological sample is stained with a light-absorbing contrast-enhancing agent; collecting a second plurality of photons reflected or transmitted from the illuminated portion to thereby obtain a hyperspectral absorption image of the portion of the sample; and observing manifestations of chemical interactions between the contrast-enhancing agent and one or more constituents of the biological sample by analyzing spectral content of a plurality of regions in the hyperspectral absorption image.

A system and method of hyperspectral chemical imaging (fluorescence or absorption based) according to one embodiment of the present disclosure provides an automated approach for a more detailed analysis of disease status of a biological sample. When a biological sample is labeled with a fluorescent or light-absorbing contrast-enhancing agent, interactions between the contrast-enhancing agent and one or more constituents (or cellular components) of the biological sample may be manifested through spectral contents of a plurality of regions in a hyperspectral chemical image of the sample. Observations of such manifestations through analysis of corresponding spectral contents may greatly assist a user (e.g., a pathologist) in detecting and differentiating diseased portions of the stained sample. Two-dimensional, wide-field chemical imaging may allow detection of multiple fluorescent or light-absorbing cellular probes (or cellular contaminants) with increased specificity, while accounting for non-uniform background fluorescence or absorption. Thus, hyperspectral chemical imaging may allow to identify multiple cellular components within the biological sample and to image their distribution within the sample, thereby assisting a pathologist to successfully and more accurately identify diseased portion(s) of the sample for further diagnosis and treatment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For the present disclosure to be easily understood and readily practiced, the present disclosure will now be described for purposes of illustration and not limitation, in connection with the following figures, wherein:

FIG. 1 illustrates a brightfiled transmission image of a 2D sample portion of an exemplary H&E stained prostate tissue having a Gleason Score (GS) of 3 or 4;

FIG. 2A shows an exemplary hyperspectral fluorescence image corresponding to the same 2D field of view of the tissue sample as that was used to obtain the brightfield image in FIG. 1;

FIG. 2B shows a respective average fluorescence spectrum associated with each corresponding region of interest identified in FIG. 2A;

FIG. 3 illustrates an exemplary spectral peak-fitting that may be performed to obtain a spectral profile of the hyperspectral fluorescence image in FIG. 2A;

FIG. 4 illustrates five principal component plots that may be generated as a result of principal component analysis (PCA) of the original trace shown in FIG. 3;

FIG. 5 shows an exemplary composite RGB (false-colored) image produced using pixel-by-pixel coloring carried out for the hyperspectral fluorescence image in FIG. 2A using the colors assigned to the PCA plots in FIG. 4; and

FIG. 6 depicts an exemplary hyperspectral chemical imaging system according to one embodiment of the present disclosure.

### DETAILED DESCRIPTION

The accompanying figures and the description that follows set forth the present disclosure in embodiments of the present disclosure. However, it is contemplated that persons generally familiar with optics, operation and maintenance of optical instruments (including spectroscopic instruments), or optical spectroscopy will be able to apply the teachings of the present disclosure in other contexts by modification of certain details. Accordingly, the figures and description are not to be taken as restrictive of the scope of the present disclosure, but are to be understood as broad and general teachings. In the discussion herein, when any numerical range of values is referred or suggested, such range is understood to include each and every member and/or fraction between the stated range of minimum and maximum. Furthermore, in the discussion below and in the accompanying figures, same reference numerals are used to describe same or similar elements, objects, or features.

The present disclosure is based upon the observation that healthy and diseased portions of a biological tissue chemically interact differently with fluorescent or light-absorbing contrast-enhancing agents (e.g., the H&E stain, or a molecular probe), and such interactions have biological or histopathological significance. These different chemical interactions manifest in the band structures of the contrast-enhancing agent's fluorescence emission spectra or absorption spectra, which may be observed through fluorescence (or absorption) hyperspectral chemical imaging so as to detect and differentiate diseased portions of stained tissues. The fluorescence or absorption imaging may provide well-resolved and clearer images with higher spectral and spatial resolutions. Additionally, the hyperspectral fluorescence (or absorption) imaging methodology discussed herein is a reproducible and repeatable method, providing a stable approach to detection of diseased portions in a tissue, cell, or other biological sample.

In the present disclosure, the terms “tissue” and “biological sample” are used interchangeably to refer to a biological sample having one or more cells or cellular components. The term “contrast-enhancing agent” is used herein to broadly refer to fluorophores or light absorbing compounds including fluorescent stains, dyes, or probes, irrespective of the underlying nature of chemical interaction between the contrast-enhancing agent and a cellular component. For example, a fluorescent stain may be a reactionary agent that chemically interacts with a cellular component, whereas a molecular or cellular probe may bind with a cellular component to form a chemical bond therebetween. However, for ease of discussion, the term “contrast-enhancing agent” is broadly used herein to refer to all such fluorescent and/or light-absorbing stains, probes, and dyes. Furthermore, also for ease of discussion, the subtle chemical differences between the actions of “staining” (or “labeling”) (e.g., in case of a fluorescent stain) and “embedding” (e.g., embedding of molecular or cellular probes or dyes into a tissue) are ignored herein. Hence, the mention of the actions of “staining” or “labeling” may be construed to refer to the action of “embedding” depending on the context of discussion. For example, in the discussion below, a general reference to a tissue “stained” or “labeled” with a “contrast-enhancing agent” may include the specific instances of staining of the tissue with a fluorescent stain (e.g., the H&E stain) or embedding of one or more molecular probes within the tissue, depending on the context of discussion. Similarly, a general reference to “interactions” between a contrast-enhancing agent and constituents of a biological sample may include actions of fluorescent stains as well as of fluorescent cellular probes or dyes, regardless of specific underlying chemical processes resulting from the actions of “staining” and “embedding.”

It is further observed at the outset that the term “hyperspectral fluorescence image” is used herein to refer to a two-dimensional spatially-accurate wavelength-resolved image obtained from a plurality of wavelength-specific fluorescence images, wherein each wavelength-specific image is obtained from collection of those fluorescence emitted photons from an illuminated sample's two dimensional (2D) field of view (FOV) that have the specific imaging wavelength (or band of wavelengths) selected from a predetermined wavelength range of interest. Widefield illumination may be used to illuminate the sample's 2D FOV. The plurality of wavelength-specific fluorescence images may be visualized to create a hyperspectral image cube having 2D spatial dimensions along the X-Y axes and representing discrete wavelengths along the Z-axis. All individual wavelength-specific fluorescence images in the image cube may be then combined to obtain the 2D “hyperspectral fluorescence image.” Thus, the entire fluorescence spectrum (spanning the predetermined wavelength range of interest) obtained from a physical location in the sample may be associated with a corresponding mapped pixel in the 2D hyperspectral fluorescence image of the sample's 2D FOV. In other words, each pixel in the hyperspectral fluorescence image may have a corresponding fluorescence spectrum associated therewith depending on the mapping between the physical locations in 2D FOV and the pixels in the 2D hyperspectral fluorescence image. Similarly, when photons reflected or transmitted from an illuminated sample's 2D field of view are collected in such wavelength-specific manner, a “hyperspectral absorption image” also may be obtained. Here, the sample may have been stained with a light-absorbing compound. In the discussion below, the term “hyperspectral chemical image” may be occasionally used to refer to either a hyperspectral fluorescence image or a hyperspectral absorption image, depending on the context of discussion.

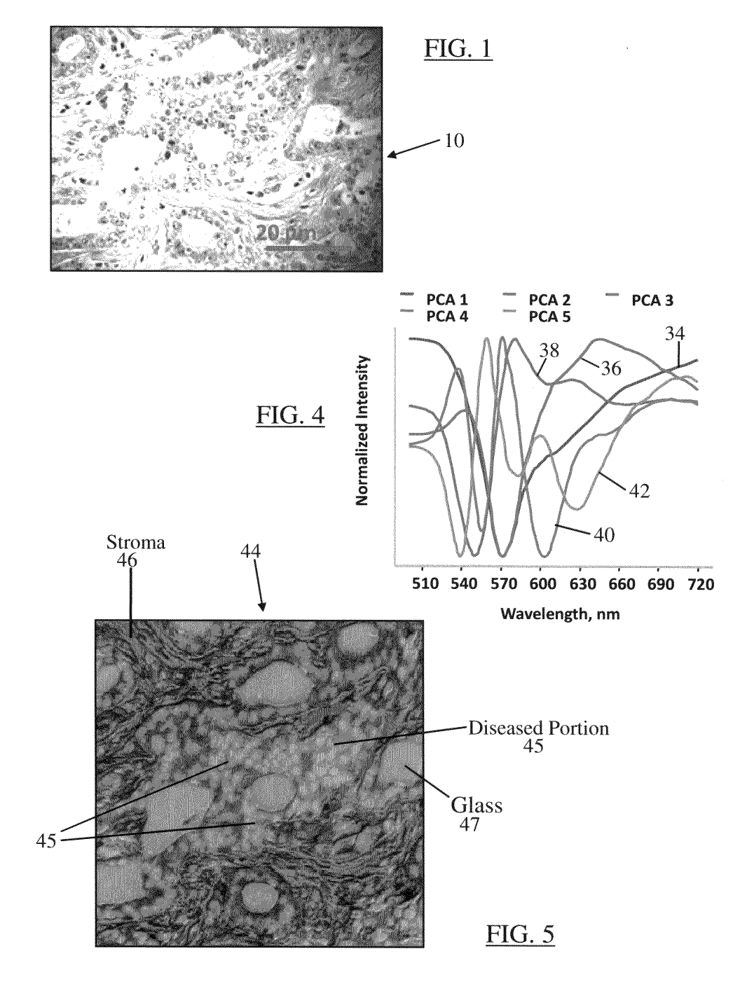

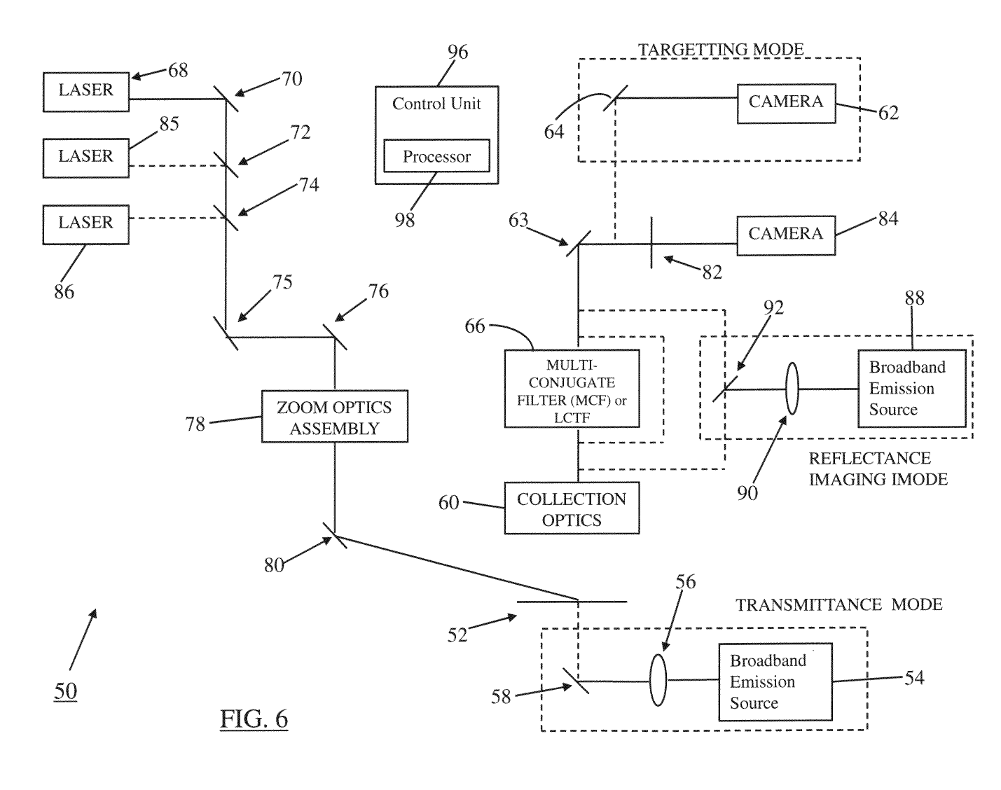

FIG. 1 illustrates a brightfiled transmission image 10 of a 2D sample portion of an exemplary H&E stained prostate tissue having a Gleason Score (GS) of 3 or 4 (e.g., the sample 52 in FIG. 6). Although H&E is used as a fluorescent contrast-enhancing agent in the embodiment of FIG. 1, other suitable fluorescent stains, dyes, or probes may be used as contrast-enhancing agents instead of H&E depending on the desired application. Some other exemplary fluorescent contrast-enhancing agents include stains such as Acridine Orange, Mason's Trichrome, or Goldner's Trichrome. Some exemplary fluorescent probes or dyes include such fluorophores as Alexa Fluor® 488, Alexa Fluor® 532, Alexa Fluor®V 680, etc., marketed by Invitrogen Corporation of California, USA, under its Molecular Probes™ product line. It is noted here that prostate cancer is a complicated, common disease in humans and other animals. Current methods of diagnosis of prostate cancer involve histopathological analysis of a tissue from a biopsy specimen. An experienced pathologist can provide diagnostic information in the form of a Gleason Score, which is used to make disease management decisions. The Gleason Score is based on the appearance of the stained tissue section on a microscope slide and is a measure of how far from normal the tissue appears. The Gleason Score (which can range from 2 to 10) is frequently used to classify the cancerous state of a prostate tissue. In general, a higher Gleason Score indicates a more progressed (worse) state of cancer. However, cases graded with a mid-range Gleason Score (6 and 7) are difficult to predict. Some of these cases will progress to metastatic disease, while some won't. This has major implications for not only the health of those patients who will develop invasive cancer, but also for those patients with benign disease who opt to undergo treatment, not knowing the state of their cancer. Therefore, the hyperspectral chemical imaging based methodology discussed herein may be used to assist a pathologist to more accurately analyze the sample at hand for better diagnosis and treatment options.

The brightfield image 10 in FIG. 1 was obtained using an exemplary chemical imaging system 50 depicted in FIG. 6 and discussed later hereinbelow. A broadband white light source 54 (e.g., a tungsten lamp) may be used to illuminate the stained prostate tissue sample 52 (FIG. 6) in the transmittance mode as illustrated in FIG. 6. Because of interactions of H&E stain with various cellular components of the tissue sample, H&E stained nuclei appear blue in the brightfield microscopic image 10 whereas the cytoplasm stains pink. As mentioned before, a different stain or probe may result in display of different stain-specific or probe-specific colors in the sample's microscopic image. Knowledge of stain-specific color profile of a particular tissue may assist a pathologist to expeditiously evaluate disease status of the tissue under investigation.

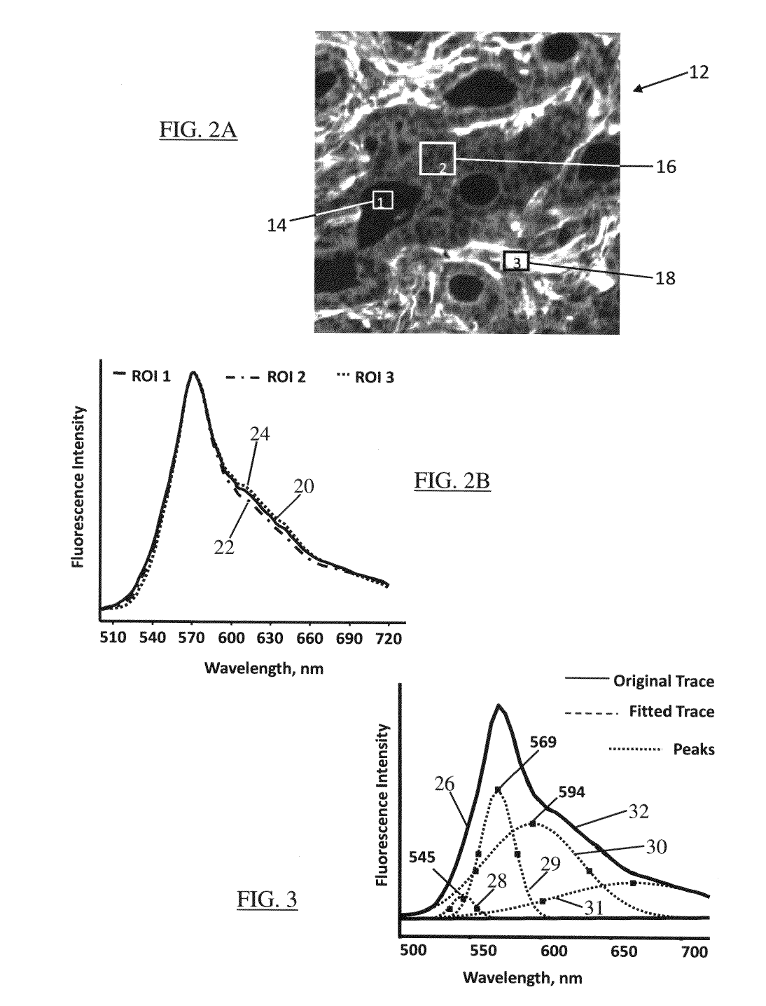

FIG. 2A shows an exemplary hyperspectral fluorescence image 12 corresponding to the same 2D field of view of the tissue sample 52 as that was used to obtain the brightfield image in FIG. 1. The same stained tissue 52 was imaged in FIGS. 1 and 2A using the chemical imaging system 50 in FIG. 6 The sample 52 was illuminated using a monochromatic light source (e.g., a laser diode) and photons emitted from the illuminated portion of the sample 52 were collected at a predetermined number of discrete wavelengths (which were selected using a liquid crystal tunable filter as discussed below with reference to FIG. 6) in a selected wavelength range of interest. Each wavelength-specific fluorescence spectral image (individual images not shown) was generated using an electron-multiplying charge coupled device (EMCCD) camera (e.g., the camera 84 in the system 50 in FIG. 6). The hyperspectral fluorescence image 12 was then obtained by combining (in software) such discrete wavelength-specific fluorescence spectral images. In the embodiment of FIG. 2A, the laser excitation wavelength was 488 nm (=488 nm) with approximately 40 mW of laser power; the emitted photons were initially collected using a 20× objective; each discrete image frame wavelength was selected using a liquid crystal tunable filter that was tuned in 5 nm steps over a predetermined wavelength range of interested spanning from approximately 490 nm to 720 nm; the EMCCD gain was set at 100 and fluorescence emitted photons were collected over the full chip of EMCCD, wherein data for each CCD image frame were read in one reading operation with 2×2 binning and 5 seconds of integration time.

In the hyperspectral fluorescence image 12 in FIG. 2A, three regions of interest (ROI) 14, 16, 18 have been identified. The fluorescence spectra associated with all pixels in the identified ROI may be averaged to obtain an average fluorescence spectrum associated with a region of interest. FIG. 2B shows a respective average fluorescence spectrum associated with each corresponding region of interest identified in FIG. 2A. Thus, in FIG. 2B, fluorescence spectra 20, 22, and 24 correspond to regions of interest 14, 16, and 18, respectively, in FIG. 2A. It is observed from the spectra in FIG. 2B that different regions in the sample provide distinct, albeit overlapping, fluorescence spectra. Image analysis and chemometric tools may be used, as discussed below, to further distinguish cellular components or differentiate between diseased and non-diseased tissue portions in the sample 52 that give rise to such closely-spaced fluorescence spectra 20, 22, 24.

FIG. 3 illustrates an exemplary spectral peak-fitting that may be performed to obtain a spectral profile of the hyperspectral fluorescence image 12 in FIG. 2A. Initially, an original spectral trace 26 representing a fluorescence spectrum that is an average of all pixel-specific spectra in the entire fluorescence image 12 may be generated using appropriate software. Thus, spectral intensities associated with each pixel in the image 12 may contribute to the generation of the original trace 26. Thereafter, spectral peak-fitting may be carried out to identify various individual spectral peaks or spectral signatures that may be constituent components of the original trace 26. In the embodiment of FIG. 3, four such spectral components 28-31 have been identified. However, three of these spectral components (i.e., spectral components 28-30) appear to have spectral peaks that may be of further interest—these spectral peaks appear at 545 nm, 569 nm, and 594 nm in the embodiment of FIG. 3. The identified spectral components 28-30 then may be merged to generate a fitted trace 32. If the fitted trace 32 substantially overlaps the original trace 26, then the identified spectral components 28-31 may be considered to be associated with the original trace 26. However, if there are significant deviations between the fitted trace 32 and the original trace 26, then further peak-fitting may be carried out to more clearly identify spectral components of the original trace 26.

When there is more than one spectral component having a distinguishable spectral signature or peak (e.g., as in the case of components 28-30 in FIG. 3), it may indicate that the original trace 26 represents spectral signatures from more than one cellular component in the tissue sample 52. Similarly, spectral profile of a pixel in the hyperspectral image 12 (FIG. 2A) may have a signature of more than one cellular component from the mapped location in the sample FOV. In either event, image analysis and chemometric tools (e.g., principal component analysis (PCA)) may be used to accurately deconvolve the original trace 26 and identify its distinct spectral components. On the other hand, if there is only one distinguishable spectral peak associated with the original trace 26, additional chemometric analysis may not be needed. In the context of FIG. 3, however, it is evident that chemometric analysis may be preferable. A chemometric tool may be used as part of qualitative image analysis to address a simple question: “What cellular components are present in the tissue and how are they distributed?” A tissue image (e.g., the image 44 shown in FIG. 5) identifying such cellular components along with their distribution may greatly assist a decision-maker (e.g., a pathologist) in providing a more accurate diagnosis of the disease state of the tissue.

It is noted here that PCA is a classification technique employing a data space dimensionality reduction approach. A least squares fit is drawn through the maximum variance in the n-dimensional dataset. The vector resulting from this least squares fit is termed the first loading. The projection of data on the first loading is called the first score. The first loading and the first score together may be referred to as the first principal component (PC). After subtracting the variance explained from the first PC, the operation is repeated and the second principal component is calculated. This process is repeated until some percentage of the total variance in the data space is explained (normally 95% or greater). PC Score images (not shown) can then be visualized to reveal orthogonal information including sample information, as well as instrument response, including noise. In other embodiments of the present disclosure, various other chemometric tools or analysis methods such as, for example, correlation techniques including the cosine correlation or Euclidean distance correlation techniques; classification techniques including cluster analysis, discriminant analysis, Mahalanobis distance analysis, and multi-way analysis; and spectral deconvolution techniques including linear spectral unmixing, multivariate curve resolution, and spectral mixture resolution (SMR) analysis may also be used in addition to or in place of the principal component analysis method discussed herein.

FIG. 4 illustrates five principal component (PC) plots 34, 36, 38, 40, 42 that may be generated as a result of principal component analysis (PCA) of the original trace 26 in FIG. 3. It is noted here that, if needed, additional principal components beyond the initial five components shown in FIG. 4 may also be explored. However, if PCA produces principal components having peaks that match the peaks of the relevant identified spectral components 28-30 (FIG. 3) or when a desired dimensionality reduction of the spectral data space is achieved (i.e., when the spectral data space is considered to be “adequately represented” through a selected set of principal components), then further principal component analysis may not be needed. Each principal component plot 34, 36, 38, 40, and 42 may be represented using a different color as shown in FIG. 4. Spectral peaks in the fluorescence spectrum associated with each pixel in the hyperspectral fluorescence image 12 may be analyzed using the principal components 34, 36, 38, 40, 42 identified in FIG. 4. Thus, each pixel in the image 12 may be assigned a false color or a combination of colors corresponding to the individual color(s) assigned to the principal component(s) represented in the fluorescence spectrum associated with that pixel.

FIG. 5 shows an exemplary composite RGB (false-colored) image 44 produced using pixel-by-pixel coloring carried out for the hyperspectral fluorescence image 12 (FIG. 2A) as discussed above using the colors assigned to the PCA plots 34, 36, 38, 40, and 42 in FIG. 4. In the RGB image 44, various tissue regions (e.g., diseased portions 45 vs. stroma 46) are clearly and easily identifiable based on the corresponding differences in the fluorescence spectra (as represented through respective PC plots) of non-diseased or other types of tissue portions (e.g., stroma 46) and diseased portions 45. Furthermore, locations or distribution of various tissue portions or cellular components also may be identified in the false-colored image 44. In one embodiment, as shown in FIG. 5, non-cellular materials (e.g., a glass substrate 47 holding the tissue sample 52 (FIG. 6) under investigation) may also be clearly identified based on identification of PC plots associated with their fluorescence spectra. The clarity of RGB images generated using the hyperspectral fluorescence imaging of stained tissues as discussed hereinbefore can assist a pathologist or other medical professional to expeditiously (in a matter of minutes) and clearly identify diseased regions in a sample and, hence, to better focus on relevant portions of the sample for further analysis and treatment.

It is observed here that a database may be generated using known fluorescence spectral signatures of various tissue portions (diseased and non-diseased) or cellular components in different types of stained tissues (e.g., prostate samples, kidney tissues, breast cancer tissues, liver tissues, etc.) that may be used as “reference samples.” Such a database may be consulted later during diagnosis of a tissue sample whose type may be known (e.g., a prostate tissue or a kidney tissue), but whose disease status needs to be ascertained using the hyperspectral fluorescence imaging methodology discussed herein. In view of prevalence of tissue staining in pathological laboratories over the years and, hence, availability of a large number of “reference” stained tissue samples and known information related to the disease diagnosis and subsequent fate of each patient linked to the respective “reference” sample, it may be easier to construct a database containing “reference” fluorescence spectral signatures of various tissue portions (diseased and non-diseased) of different types of tissue samples. In one embodiment, such pre-existing diagnosis information and known information about subsequent fate of the respective patient may be used to validate the results obtained by applying the hyperspectral fluorescence chemical imaging approach discussed herein to such known or “reference” tissue samples. In this manner, the hyperspectral fluorescence imaging based disease status diagnosis model according to one embodiment of the present disclosure may be made more robust, thereby further providing more accurate detection and diagnosis information to a medical practitioner in need of such additional “insight.” It is observed here that a Raman-spectroscopy or spectral imaging based approach may not greatly benefit from availability of such pre-existing stained samples because of the need to avoid or suppress fluorescence in Raman-based experiments.

When a biological sample is labeled with more than one contrast-enhancing agent, the hyperspectral fluorescence and absorption imaging methodologies discussed herein may be equally used to identify cellular components (through the observation of spectral manifestations of interactions between various contrast-enhancing agents and cellular components), to detect their locations within the biological sample (e.g., by imaging their distribution within the sample), and to understand the chemical environment (e.g., cellular chemistry) within the biological sample.

FIG. 6 depicts an exemplary hyperspectral chemical imaging system 50 according to one embodiment of the present disclosure. It is noted at the outset that only a schematic layout of the system 50 is shown in FIG. 6 for ease of illustration and discussion. It is evident to one skilled in the art that the actual system 50 may contain many additional optical, electrical, or mechanical components to properly operate the system 50, but such additional components or details are not shown in FIG. 6 for the sake of brevity and ease of illustration. The system 50 may be used to perform hyperspectral chemical imaging (fluorescence and absorption (in either the transmission or reflection mode)) to diagnose the disease status of a biological sample as per the teachings of the present disclosure. The system 50 may be configured to receive a stained sample 52 (e.g., a biological sample or tissue under investigation) that may have been mounted on a glass substrate (not shown). An initial brightfield transmission image (e.g., similar to the image 10 in FIG. 1) of the stained sample may be obtained by illuminating the sample using a broadband light (white light) source 54 in combination with a focusing lens 56 and a folding mirror 58. A collection optics unit 60 (e.g., a microscope objective with or without additional lens assembly) may be configured to collect the photons transmitted, emitted, or reflected from the illuminated stained sample 52. In one embodiment, photons collected by the collection optics 60 to generate the brightfield transmission image may be directly provided to a targeting camera 62 (via respective mirrors 63, 64) without filtering the photons through a tunable optical filter (or spectral filter) 66. The targeting camera 62 may be a CCD (charge coupled device) or a CMOS (complementary metal oxide semiconductor) based photon detection camera (e.g., a color or black-and-white CCD or CMOS camera). In an alternative embodiment, a focal plane detector (FPA) array may be used instead of the camera 62. It is observed here that system units (e.g., the tunable filter 66, or the targeting camera 62, or the broadband light sources 54, 88) shown by dotted portions in the system 50 may be optionally and interchangeably engaged in various optical paths as per the desired application.

In case of hyperspectral fluorescence imaging, a monochromatic light source (e.g., a laser diode 68) may be used to illuminate the sample 52 with photons having a predetermined illumination wavelength (In one embodiment, the laser illumination may be provided at an oblique angle (e.g., as illustrated in FIG. 6) instead of vertically onto the sample 52. In an alternative embodiment, the illuminating photons may be provided using the collection optics 60, which may function as a common conduit for the illuminating as well as imaging photons. In the embodiment of FIG. 6, the laser illumination path may include a number of ancillary components such as, for example, folding mirrors 70, 75, 76, and 80, a pair of dichroic mirrors 72, 74, and an optical zoom assembly 78. The zoom optics assembly 78 may be useful in case of variable magnification illumination of the sample FOV (e.g., a 2D widefield illumination, a single dimensional point-by-point illumination, etc.). In one embodiment, λₑₓ=488 nm. Other lasers (e.g., lasers 85, 86) with different excitation wavelengths (e.g., 532 nm, 680 nm, etc.) may also be provided depending on the desired excitation for the fluorescent stain or probe. For example, in case of the Alexa Fluor® 488 probe, the excitation wavelength may be 488 nm; whereas in case of the Alexa Fluor® 532 probe, the excitation wavelength may be 532 nm. Thus, the selection of a suitable laser excitation wavelength may depend on the fluorescence characteristics of the stain or probe in the stained sample as well as of the cellular material in the sample. One or more laser diodes 68, 85, 86 may be replaced with other types of monochromatic illumination sources such as, for example, a light emitting diode (LED) or a white lamp used in conjunction with a monochromator (or a prism) to provide monochromatic illumination having excitation wavelength suitable for the fluorescent contrast-enhancing agent in use.

The fluorescence emitted photons from the illuminated sample 52 may be collected by the collection optics 60 and provided to the tunable optical filter 66 whose birefringence may be electronically tunable so as to selectively transmit photons having a selected wavelength or a selected wavelength band. In this manner, wavelength-specific photons may be transferred to a detector unit 84 (e.g., via a folding mirror 63 and rejection filter 82) to generate a plurality of wavelength-specific fluorescence spectral images of the sample's illuminated FOV. The rejection filter 82 may prevent photons having the illumination wavelength (λₑₓ) from reaching the detector unit 84, but may transmit all other photons to the detector unit 84. In one embodiment, the detector unit 84 may be a CCD or a CMOS detector (e.g., a black-and-white CCD or CMOS camera). In an alternative embodiment, the detector unit 84 may include a focal plane array (FPA) detector. In one embodiment, the outputs of the cameras 62, 84 may be provided in a digitized form so as to facilitate further processing of optical data (e.g., display of an image on an electronic display unit such as a computer monitor).

In one embodiment, the tunable filter 66 may be a liquid crystal-based tunable optical filter such as, for example, a Lyot liquid crystal tunable filter (LCTF), an Evans Split-Element LCTF, a Solc LCTF, a Ferroelectric LCTF, a liquid crystal Fabry Perot (LCFP), or a hybrid filter comprised of a combination of the above-mentioned LC filter types or the above mentioned filter types in combination with fixed bandpass and bandreject filters comprised of dielectric, rugate, holographic, color absorption, acousto-optic, or polarization types. In one embodiment, a multi-conjugate filter (MCF) may be used instead of a simple LCTF to provide more precise wavelength tuning of photons received from the sample 52. Some exemplary multi-conjugate filters are discussed, for example, in U.S. Pat. No. 6,992,809, titled “Multi-Conjugate Liquid Crystal Tunable Filter;” and in the U.S. Published Patent Application Number US2007/0070260A1, titled “Liquid Crystal Filter with Tunable Rejection Band,” the disclosures of both of these publications are incorporated herein by reference in their entireties. In one embodiment, the tunable filter 66 may be a bandpass filter or a filter having a very narrow passband. In another embodiment, the tunable filter 66 may be configured to filter photons in a predetermined wavelength range (e.g., from approximately 490 nm to 720 nm) with a predetermined tuning step size (e.g., in 5 nm tuning steps). The controllable tuning step size may result in N-dimensional data (where N=number of tuning steps), wherein each dataset in the N-dimensional data may represent wavelength-specific spectral data that may be used to generate individual wavelength-specific spectral images.

In a different embodiment, the tunable filter 66 may be replaced with a gratings-based dispersive spectrometer (not shown) or a system that employs wavelength dispersion-based spectral data collection. A fiber array spectral translator (FAST) based chemical imaging system may be used to collect wavelength-specific spectral images using dispersive spectrometry.

In a further embodiment, an optional hyperspectral absorption (by reflection) imaging functionality may be provided in the system 50 using a broadband emission source 88 (e.g., a tungsten lamp) in combination with a focusing lens 90 and folding mirror 92. The illumination from the emission source 88 may be directly focused on the sample in an oblique manner (e.g., similar to the focusing of the illumination from the laser source 68) using the combination of the lens 90 and the mirror 92 (and probably one or more additional mirrors or other optical focusing components not shown in FIG. 6). Alternatively, the broadband illumination from the emission source 88 may be supplied to the sample 52 via the collection optics 60. In such an embodiment, the collection optics 60 may be used to provide illuminating photons as well as to collect photons reflected from the sample 52. In the reflectance imaging mode, photons reflected from the sample 52 may be collected by the collection optics 60 and provided to the tunable filter 66 so as to pass wavelength-specific portions of collected photons to the detector unit 84, which may then generate optical data to enable viewing of wavelength-specific spectral images of the 2D FOV of the illuminated sample 52 and to also enable viewing of the hyperspectral reflectance image of the sample 52 by combining individual wavelength-specific spectral images of the sample. It is noted here that some of the illuminating photons reaching the sample 52 may be absorbed by the sample and/or by the contrast-enhancing agent in the sample. Hence, photons reflected from the sample may represent absorption characteristics of the sample 52 labeled with a contrast-enhancing agent. Thus, one skilled in the art may observe that a hyperspectral image of such reflected photons also represents a hyperspectral absorption image of the sample 52. Because the discussion provided hereinbefore with respect to the analysis of a hyperspectral fluorescence image (e.g., the image 12 in FIG. 2A) equally applies to the analysis of a hyperspectral reflectance image, such discussion is not repeated herein for the sake of brevity. In summary, a hyperspectral reflectance (and, hence, absorption) image of the sample 52 may be analyzed in the manner similar to that discussed hereinbefore with reference to FIGS. 2A through 5 so as to provide a detailed analysis of disease status of the biological sample under investigation.

Similar to hyperspectral absorption imaging by reflection, in one embodiment, the system 50 in FIG. 6 may be used to provide hyperspectral absorption imaging by transmission. In this embodiment, the combination of the broadband emission source 54, focusing lens 56, and folding mirror 58 (and probably one or more additional mirrors or other optical focusing components not shown in FIG. 6) may be used to “back-illuminate” the sample 52 in a “transmittance mode.” It may be observed by one skilled in the art that some of the illuminating photons reaching the sample 52 may be absorbed by the sample and/or by the contrast-enhancing agent in the sample. Hence, photons transmitted from the illuminated sample may represent absorption characteristics of the sample 52 labeled with a contrast-enhancing agent. The transmitted photons may be collected by the collection optics 60 and provided to the tunable filter 66 so as to pass wavelength-specific portions of collected photons to the detector unit 84, which may then generate optical data to enable viewing of wavelength-specific spectral images of the 2D FOV of the illuminated sample 52 and to also enable viewing of the hyperspectral transmittance image of the sample 52 by combining individual wavelength-specific spectral images of the sample. Thus, one skilled in the art may observe that a hyperspectral image of such transmitted photons also represents a hyperspectral absorption image of the sample 52. Because the discussion provided hereinbefore with respect to the analysis of a hyperspectral fluorescence image (e.g., the image 12 in FIG. 2A) equally applies to the analysis of a hyperspectral transmittance image, such discussion is not repeated herein for the sake of brevity. In summary, a hyperspectral transmittance (and, hence, absorption) image of the sample 52 may be analyzed in the manner similar to that discussed hereinbefore with reference to FIGS. 2A through 5 so as to provide a detailed analysis of disease status of the biological sample under investigation.

An exemplary discussion of hyperspectral absorption imaging is provided in the U.S. Patent Application Publication No. US2007-0019198 to Tuschel et al. (U.S. patent application Ser. No. 11/527,112), titled “Hyperspectral Visible Absorption Imaging of Molecular Probes and Dyes in Biomaterials,” published on Jan. 25, 2007, and assigned to the assignee of the instant application, the disclosure of which is incorporated herein by reference in its entirety.

In one embodiment, a control unit 96 may be provided to control operations of various components in the system 50, thereby fully or partially automating the functionality of the imaging system 50. In one embodiment, various optical and spectral data (e.g., fluorescence emission data) collected using the system 50 were processed using the ChemImage Xpert™ software, which was also used to perform other data processing functionalities (e.g., principal component analysis of spectral data, generation of a false-colored image, etc.). In another embodiment, a programmable processor 98 (e.g., a central processing unit (CPU), a microprocessor, etc.) may be provided as part of the control unit 96. The processor 98 may be configured to execute software instructions (including, for example, the ChemImage Xpert™ software) to automate performance of various data processing tasks discussed hereinbefore (e.g., PCA of spectral data, generation of hyperspectral fluorescence images from emission-collected photons, generation of false-colored images to depict distribution of cellular components in tissues, etc.). In an alternative embodiment, a display unit (e.g., a computer monitor, a liquid crystal display, a visual display unit, etc.) (not shown) also may be provided to operate as part of or in conjunction with the system 50 in FIG. 6. The display unit may be used to visually depict various spectral images, spectral plots, false-colored images, chemical images, or other data that may be of use to a medical professional investigating the sample 52 using the system 50 and its operative software. It is noted, however, that other chemical imaging systems and software may be suitably used to carry out the teachings of the present disclosure.

In an alternative embodiment, a sample requiring analysis of its disease status may be sent to a remote laboratory, which may analyze the sample using a hyperspectral chemical imaging system (e.g., a system similar to the system 50 in FIG. 6) and may electronically provide results of its disease status (e.g., a false-colored image of the distribution of diseased portions within the sample) to the requester of such services via a data communication network (e.g., the Internet). Thus, a commercial, Internet-based (or other wireline or wireless data communication network-based) sample analysis and testing service may be provided using various teachings of the present disclosure.

From the foregoing it is observed that in case of a biological sample labeled with a contrast-enhancing agent, interactions between the contrast-enhancing agent and one or more constituents (or cellular components) of the biological sample may be manifested through spectral contents of a plurality of regions in a hyperspectral chemical image of the sample. Observations of such manifestations through analysis of corresponding spectral contents may greatly assist a user (e.g., a pathologist) in detecting and differentiating diseased portions of the stained sample. The stained sample may be a mammalian tissue including, for example, a human prostate tissue, a human kidney tissue, a human liver tissue, a human breast cancer tissue, a human skin tissue, etc. The hyperspectral chemical imaging approach discussed herein uses two-dimensional wide-field chemical imaging that may allow detection of multiple fluorescent or light-absorbing cellular probes (or cellular contaminants) with increased specificity, while accounting for non-uniform background fluorescence or absorption. Thus, hyperspectral chemical imaging may allow to identify multiple cellular components within the biological sample and to image their distribution within the sample. The results provided by hyperspectral chemical imaging may be more accurate and reliable because the analysis and its interpretation are rooted in spectroscopy.

The subtle changes in the emission (or absorption) peak positions and band shape of emission (or absorption) spectra of a contrast-enhancing agent may be observed through spectral analysis of a hyperspectral chemical image of a biological sample labeled with the contrast-enhancing agent. Such spectral analysis may also provide information about how various cellular components are bound in the sample and what is the chemical environment of these various components within the sample. The spectral data acquisition and analysis may be substantially automated, thereby significantly expediting machine-based analysis of disease status of a tissue sample. Such machine-based analysis not only complements the results obtained by a visual inspection of the stained tissue by a human pathologist, but also provides a more detailed analysis of disease status of the tissue sample, which may be additionally beneficial to the pathologist to successfully and more accurately identify diseased portion(s) of the sample for further diagnosis and treatment.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method comprising:
illuminating a two dimensional (2D) portion of a biological sample with a first plurality of photons from a monochromatic light source, wherein said biological sample is stained with a fluorescent contrast-enhancing agent;
collecting a second plurality of photons emitted from said illuminated portion to thereby obtain a hyperspectral fluorescence image of said portion of the sample; and
observing manifestations of chemical interactions between said contrast-enhancing agent and one or more constituents of said biological sample by analyzing spectral content of a plurality of regions in said hyperspectral fluorescence image.

2. The method of claim 1, wherein said contrast-enhancing agent is selected from the group consisting of Haematoxyn and Eosin (H&E), Acridine Orange, Mason's Trichrome, and Goldner's Trichrome.

3. The method of claim 1, wherein said monochromatic light source is selected from the group consisting of a diode laser, a light emitting diode (LED), and a combination of a white lamp and a monochromator.

4. The method of claim 1, wherein said monochromatic light source is configured to provide said first plurality of photons at an illumination wavelength of approximately 488 nm.

5. The method of claim 1, wherein collecting said second plurality of photons includes collecting said second plurality of photons over a plurality of predetermined wavelengths.

6. The method of claim 5, wherein said plurality of predetermined wavelengths includes wavelengths in the range of approximately 490 nm-720 nm.

7. The method of claim 5, wherein collecting said second plurality of photons includes using an electronically tunable optical filter to filter wavelength-specific portions of said second plurality of photons across said plurality of predetermined wavelengths in a predetermined filter step size.

8. The method of claim 7, wherein said predetermined filter step size is 5 nm.

9. The method of claim 7, wherein said tunable optical filter is one of the following: a liquid crystal tunable filter (LCTF); a multi-conjugate filter; and an optical filter having electronically-tunable birefringence.

10. The method of claim 5, wherein collecting said second plurality of photons includes:
collecting a plurality of wavelength-specific spatial images of said 2D portion over said plurality of predetermined wavelengths; and
obtaining said hyperspectral fluorescence image from said plurality of wavelength-specific spatial images.

11. The method of claim 1, wherein said contrast-enhancing agent is a cellular probe selected from the group consisting of Alexa Fluor® 488, Alexa Fluor® 532, and Alexa Fluor® 680.

12. The method of claim 1, wherein analyzing said spectral content includes:
obtaining an average fluorescence spectrum associated with said hyperspectral fluorescence image;
performing spectral peak-fitting to identify one or more spectral components relevant to said average fluorescence spectrum; and
using said one or more spectral components to deconvolve said average fluorescence spectrum into one or more component spectra, wherein each component spectrum manifests an interaction between said contrast-enhancing agent and one of the constituents of said biological sample.

13. The method of claim 12, wherein analyzing said spectral content further includes:
selecting one or more image pixels in each of said plurality of regions in said hyperspectral fluorescence image; and
determining a spectral profile of each selected image pixel, wherein each said spectral profile includes one or more of said component spectra present in a fluorescence emission spectrum associated with the selected image pixel, and wherein each said spectral profile represents an interaction between said contrast-enhancing agent and said one or more constituents of said biological sample at a location in said 2D portion that is associated with the selected image pixel.

14. The method of claim 13, further comprising:
identifying said one or more constituents of said biological sample at each location in said 2D portion associated with a corresponding selected image pixel using said spectral profile of said corresponding selected image pixel.

15. The method of claim 14, further comprising:
generating a false-colored image depicting distribution of said one or more constituents of said biological sample throughout said 2D portion.

16. The method of claim 1, wherein said biological sample is one of the following: a prostate tissue; a kidney tissue; a liver tissue; a breast cancer tissue; a skin tissue.

17. The method of claim 1, further comprising:
providing to a user a result conveying said manifestations of interactions between said contrast-enhancing agent and said one or more constituents of said biological sample.

18. The method of claim 17, wherein said result includes identification of diseased and non-diseased portions in said biological sample.

19. A system comprising:
a monochromatic illumination source configured to illuminate a two dimensional (2D) portion of a biological sample with a first plurality of photons, wherein said biological sample is stained with a fluorescent contrast-enhancing agent;
a collection optics to collect a second plurality of photons emitted from said illuminated portion of the sample;
a detector unit configured to receive at least a portion of said second plurality of photons from said collection optics and to enable generation of a hyperspectral fluorescence image of said portion of the sample from the received portion of said second plurality of photons; and
a processing unit coupled to said detector unit and configured to enable observation of manifestations of chemical interactions between said contrast-enhancing agent and one or more constituents of said biological sample by analyzing spectral content of a plurality of regions in said hyperspectral fluorescence image.

20. The system of claim 19, wherein said detector unit is one of the following: a charge coupled device (CCD) detector; and a complementary metal oxide semiconductor (CMOS) detector.

21. The system of claim 19, further comprising:
an electronically tunable optical filter operatively placed between said collection optics and said detector unit, wherein said tunable optical filter is configured to receive said second plurality of photons from said collection optics and to provide wavelength-specific portions of said second plurality of photons to said detector unit across a plurality of predetermined wavelengths; and
wherein said detector unit is configured to collect said wavelength-specific portions of said second plurality of photons so as to enable generation of a plurality of wavelength-specific spatial images of said 2D portion therefrom, wherein said hyperspectral fluorescence image is obtained from said plurality of wavelength-specific spatial images.

22. The system of claim 21, wherein said tunable optical filter is one of the following: a liquid crystal tunable filter (LCTF), a multi-conjugate filter, and an optical filter having electronically-tunable birefringence.

23. The system of claim 19, wherein said processing unit is configured to perform the following:
obtain an average fluorescence spectrum associated with said hyperspectral fluorescence image;
implement spectral peak-fitting to identify one or more spectral components relevant to said average fluorescence spectrum;
use said one or more spectral components to deconvolve said average fluorescence spectrum into one or more component spectra;
select one or more image pixels in each of said plurality of regions in said hyperspectral fluorescence image;
determine a spectral profile of each selected image pixel, wherein each said spectral profile includes one or more of said component spectra present in a fluorescence emission spectrum associated with the selected image pixel, and wherein each said spectral profile represents an interaction between said contrast-enhancing agent and one or more constituents of said biological sample at a location in said 2D portion that is associated with the selected image pixel; and
identify said one or more constituents of said biological sample at each location in said 2D portion associated with a corresponding selected image pixel using said spectral profile of said corresponding selected image pixel.

24. The system of claim 19, wherein said processing unit is configured to generate a false-colored image depicting distribution of said one or more constituents of said biological sample throughout said 2D portion.

25. A method comprising:
illuminating a two dimensional (2D) portion of a biological sample with a first plurality of photons from a broadband light source, wherein said biological sample is stained with a light-absorbing contrast-enhancing agent;
collecting a second plurality of photons reflected or transmitted from said illuminated portion to thereby obtain a hyperspectral absorption image of said portion of the sample; and
observing manifestations of chemical interactions between said contrast-enhancing agent and one or more constituents of said biological sample by analyzing spectral content of a plurality of regions in said hyperspectral absorption image.

26. The method of claim 25, wherein collecting said second plurality of photons includes:
filtering wavelength-specific portions of said second plurality of photons across a plurality of predetermined wavelengths so as to enable generation of a plurality of wavelength-specific spatial images of said 2D portion over said plurality of predetermined wavelengths; and
obtaining said hyperspectral reflectance image from said plurality of wavelength-specific spatial images.

27. The method of claim 25, further comprising:
providing identification of diseased and non-diseased portions in said biological sample based on an analysis of the spectral content of said plurality of regions in said hyperspectral reflectance image.
